(19) United States
(12) Patent Application Publication
(10) Pub. No.: US 2026/0369745 A1
(43) Pub. Date: Nov. 19, 2026

(54) VENTILATION SYSTEM FOR BATTERY SYSTEM OF LOCOMOTIVE

(71) Applicant: Progress Rail Locomotive Inc., LaGrange, IL (US)

(72) Inventors: Ricardo Piccolotto, Maringá (BR); Bruno Luiggi Felipe da Silva, Curitiba (BR); Rafael Vieira Dalmarco, Curitiba (BR)

(73) Assignee: Progress Rail Locomotive Inc., LaGrange, IL (US)

(21) Appl. No.: 19/210,099

(22) Filed: May 16, 2025

(51) Int. Cl. H01M 10/663; B61C 17/06; H01M 10/613; H01M 10/615; H01M 10/625; H01M 10/6561; H01M 50/358

(52) U.S. Cl. CPC H01M 10/663; B61C 17/06; H01M 10/613; H01M 10/615; H01M 10/625; H01M 10/6561; H01M 50/358; H01M 2220/20

(57) ABSTRACT

A ventilation system for a battery system includes at least one duct assembly including at least one heat, ventilation, and air conditioning (HVAC) unit and an inlet assembly adapted to direct the air flow towards each of the plurality of battery compartments. The inlet assembly includes an inlet manifold, a plurality of inlet ducts extending from the inlet manifold. Each of the plurality of inlet ducts fluidly couples the inlet manifold with a corresponding battery compartment from the plurality of battery compartments. The at least one duct assembly further includes an outlet assembly adapted to receive a return air flow from the plurality of battery compartments. The outlet assembly includes an outlet manifold, a plurality of outlet ports coupled to the outlet manifold. Each of the plurality of outlet ports fluidly couples the outlet manifold with a corresponding battery compartment from the plurality of battery compartments.

### TECHNICAL FIELD

The present disclosure relates to a battery system of a locomotive, and more particularly, to a ventilation system for the battery system of the locomotive.

### BACKGROUND

A rail transport vehicle, such as a freight train or a passenger train, includes a locomotive to provide motive power to railcars or carriages. The locomotive includes a battery system to store energy for various operations such as, providing propulsion power when needed and providing power to non-propulsion systems on the rail transport vehicle such as lights, ventilation systems, and/or other electronic systems.

The battery system generates heat during operation. The heat generated during the operation of the battery system may cause thermal events, such as overheating, fire propagation, or thermal runaway of battery cells present in the battery system which may cause side effects that can jeopardize a maintenance, a performance, and a lifespan of the battery system and the rail transport vehicle. Moreover, the battery system disposed in the locomotive is expensive, and a failure of the battery system may incur significant maintenance and replacement costs. In order to perform efficiently, the battery systems need to be maintained and operated within predefined temperature limits. Further, the ventilation system is also used to warm up the battery system in cold conditions, so that the battery systems is maintained and operated within the predefined temperature limits. An efficient ventilation system to maintain components of the battery system within the predefined temperature limits is therefore desirable.

IN201941041913A describes a battery module for an electric vehicle having a plurality of cells, a first coolant circuit having a first heat exchanger, a second coolant circuit having a second heat exchanger, and a controller which is configured to receive the temperature of the plurality of cells; to activate the first heat exchanger if the temperature of one or more cells is greater than a first threshold value and less than a second threshold value; and to activate the second heat exchanger if the temperature of one or more of the cells is greater than the second threshold value. The activation of the second heat exchanger makes it possible for the coolant cooled by the cooling unit to rapidly reduce the temperature of one or more cells within a desired range of values.

### SUMMARY OF THE DISCLOSURE

In an aspect of the present disclosure, a ventilation system for a battery system of a locomotive is provided. The ventilation system includes at least one duct assembly. The at least one duct assembly includes at least one heat, ventilation, and air conditioning (HVAC) unit adapted to generate and supply an air flow towards a plurality of battery compartments of the battery system. The at least one duct assembly also includes an inlet assembly adapted to direct the air flow towards each of the plurality of battery compartments. The inlet assembly includes an inlet manifold in fluid communication with the at least one HVAC unit. The inlet assembly also includes a plurality of inlet ducts extending from the inlet manifold. Each of the plurality of inlet ducts fluidly couples the inlet manifold with a corresponding battery compartment from the plurality of battery compartments. The at least one duct assembly further includes an outlet assembly adapted to receive a return air flow from the plurality of battery compartments. The outlet assembly includes an outlet manifold in fluid communication with the at least one HVAC unit. The outlet assembly also includes a plurality of outlet ports coupled to the outlet manifold. Each of the plurality of outlet ports fluidly couples the outlet manifold with a corresponding battery compartment from the plurality of battery compartments.

In another aspect of the present disclosure, a battery system of a locomotive is provided. The battery system includes a plurality of battery compartments. The battery system also includes a ventilation system for the plurality of battery compartments. The ventilation system includes at least one duct assembly. The at least one duct assembly includes at least one heat, ventilation, and air conditioning (HVAC) unit adapted to generate and supply an air flow towards plurality of battery compartments of the battery system. The at least one duct assembly also includes an inlet assembly adapted to direct the air flow towards each of the plurality of battery compartments. The inlet assembly includes an inlet manifold in fluid communication with the at least one HVAC unit. The inlet assembly also includes a plurality of inlet ducts extending from the inlet manifold. Each of the plurality of inlet ducts fluidly couples the inlet manifold with a corresponding battery compartment from the plurality of battery compartments. The at least one duct assembly further includes an outlet assembly adapted to receive a return air flow from the plurality of battery compartments. The outlet assembly includes an outlet manifold in fluid communication with the at least one HVAC unit. The outlet assembly also includes a plurality of outlet ports coupled to the outlet manifold. Each of the plurality of outlet ports fluidly couples the outlet manifold with a corresponding battery compartment from the plurality of battery compartments.

Other features and aspects of this disclosure will be apparent from the following description and the accompanying drawings.

### BRIEF DESCRIPTION OF THE DRAWINGS

FIG. 1 is a diagrammatic side view of an exemplary rail transport vehicle including a locomotive, according to an example of the present disclosure;

FIG. 2 illustrates a schematic perspective view of a battery system of the locomotive of FIG. 1, according to an example of the present disclosure;

FIG. 3 illustrates a schematic perspective view of a ventilation system for the battery system of FIG. 2, according to an example of the present disclosure;

FIG. 4 is a schematic perspective view of an inlet assembly of the ventilation system of FIG. 3;

FIG. 5 is a schematic perspective view of a portion of a first duct assembly of the ventilation system of FIG. 3;

FIG. 6 is a schematic perspective view of a second duct assembly of the ventilation system;

FIG. 7 is a schematic perspective view of a portion of the second duct assembly of FIG. 6;

FIG. 8A is a perspective view of a battery compartment illustrating an air flow being directed to the battery compartment, according to an example of the present disclosure;

FIG. 8B is a perspective view of the battery compartment illustrating a return air flow leaving the battery compartment, according to an example of the present disclosure;

FIG. 9 is a schematic perspective view of a ventilation system, according to another example of the present disclosure;

FIG. 10 is a front view of a ventilation system, according to yet another example of the present disclosure; and

FIG. 11 is a schematic perspective view of a portion of the ventilation system of FIG. 10.

### DETAILED DESCRIPTION

Wherever possible, the same reference numbers will be used throughout the drawings to refer to the same or like parts.

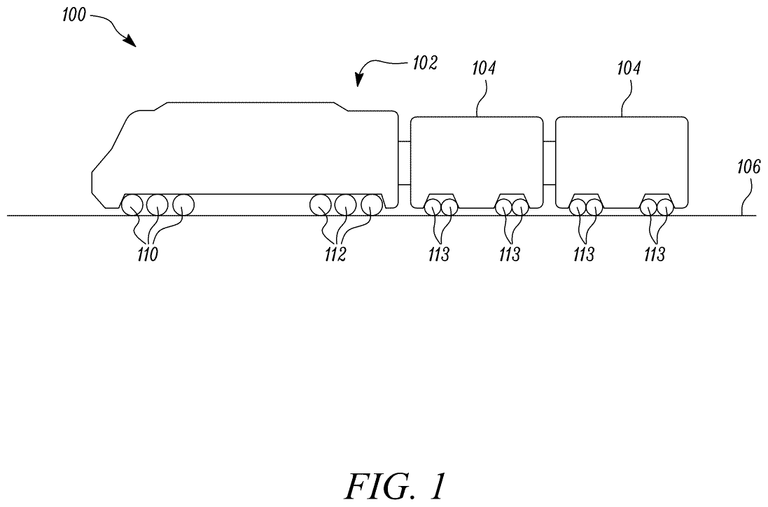

Referring to FIG. 1, a diagrammatic side view of an exemplary rail transport vehicle 100 including a locomotive 102 is illustrated. The rail transport vehicle 100 may be used in any industry, such as transportation, mining, construction, landscaping, forestry, agriculture, and so on. Non-limiting examples of vehicles, for both commercial and industrial purposes, include battery electric locomotives, trains, diesel-electric locomotives, diesel-mechanical locomotives, and so on. It is to be understood that the rail transport vehicle 100 is shown primarily for illustrative purposes to assist in disclosing features of the disclosure, and that FIG. 1 does not depict all of the components of the rail transport vehicle 100.

The rail transport vehicle 100 includes the locomotive 102. In an example, the locomotive 102 may include an electrically operated locomotive or a hybrid locomotive. The rail transport vehicle 100 also includes one or more railcars 104 coupled to the locomotive 102. In the illustrated example of FIG. 1, the rail transport vehicle 100 includes two railcars 104. The rail transport vehicle 100 may travel along a route 106 on a pair of rails/tracks. The railcars 104 may be passenger cars and/or freight cars for carrying passengers, goods, or other loads. Further, the locomotive 102 includes a number of wheels 110, 112. Further, each railcar 104 also includes a number of wheels 113.

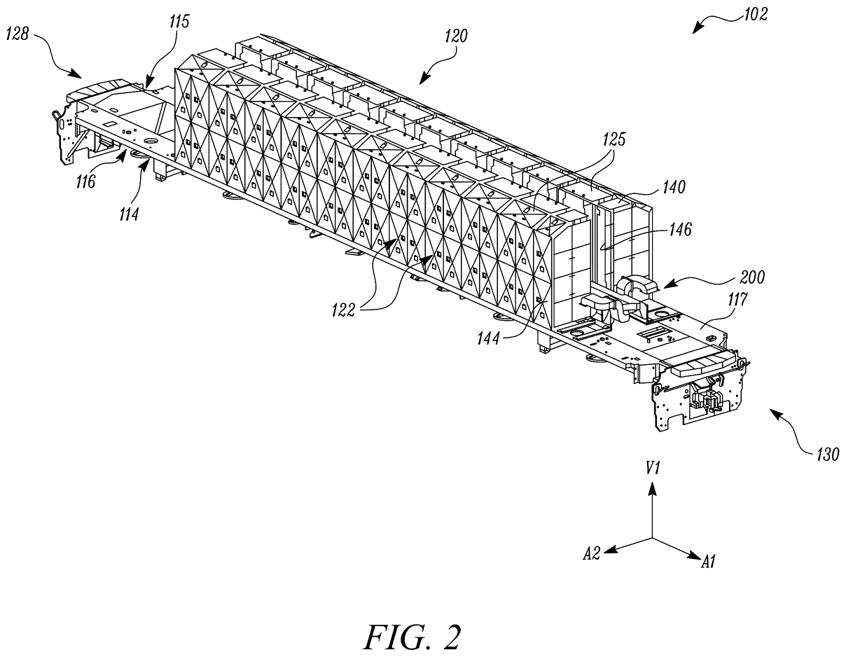

Referring to FIG. 2, a schematic perspective view of the locomotive 102 is illustrated. The locomotive 102 further includes an underframe 114. The underframe 114 is a structural frame that forms a base or a foundation of the locomotive 102, supporting all of its major components. The wheels 110, 112 (see FIG. 1) are supported by the underframe 114. The underframe 114 defines a top side 115 and an underside 116 opposite the top side 115. The underframe 114 defines a deck 117. The top side 115 and the underside 116 are disposed at opposite sides of the deck 117. The underframe 114 defines a first end 128 and a second end 130 laterally opposite to first end 128. It should be noted that a design and arrangement of components of the locomotive 102 as illustrated and explained herein is exemplary in nature, and the locomotive 102 may have any other design or arrangement of components.

The locomotive 102 further includes a battery system 120. The battery system 120 of the locomotive 102 stores energy for operation and provides energy to a propulsion system of the locomotive 102 when needed. The battery system 120 is used also to provide auxiliary power supply to non-propulsion systems on the rail transport vehicle 100, such as lights, communication equipment, and other electronic/electrical systems.

Further, the battery system 120 in different rail transport vehicles is also used for different purposes, such as providing a necessary power to activate a locomotive's prime mover, to store energy recovered during braking (regenerative braking), to supply power and act as a backup power source during breakdown or downtime of the prime mover, and to store energy for operation on non-electrified tracks or in situations where diesel power is not optimal.

The battery system 120 includes a number of battery compartments 122. The number of battery compartments 122 are disposed on the underframe 114 of the locomotive 102. The battery system 120 may include any number of battery compartments 122 based on for example, a size of the rail transport vehicle 100 or a number of railcars 104 (see FIG. 1), as per application requirements.

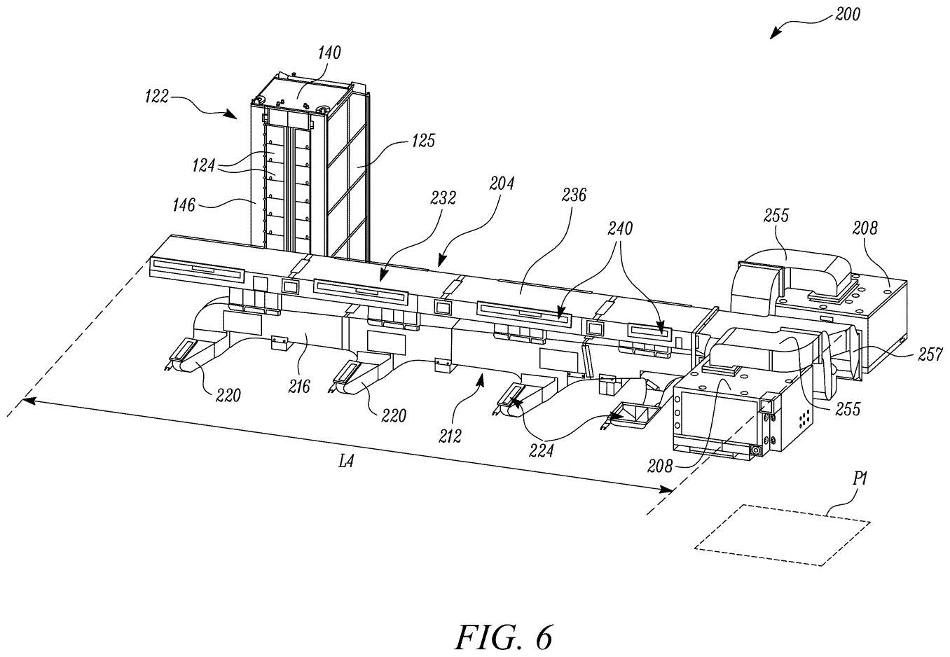

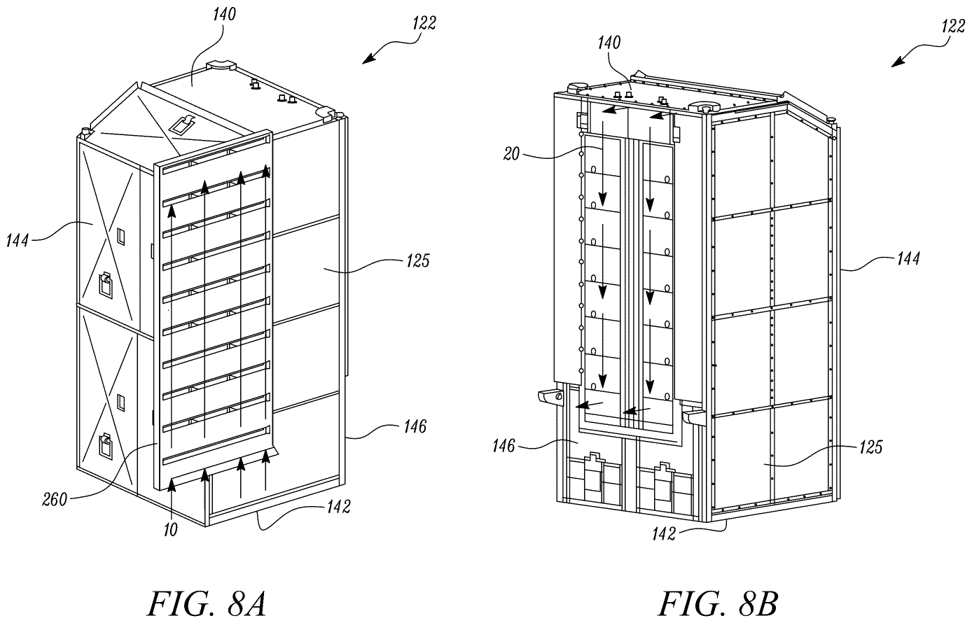

The battery compartment 122 includes a number of battery modules 124 (shown in FIG. 6) arranged in a stack inside a housing 125 of the battery compartment 122. Further, the housing 125 includes a top surface 140, a bottom surface 142 (shown in FIG. 8A), a front surface 144, and a rear surface 146.

Further, as an example, the battery compartments 122 are disposed in two sets. The sets of the battery compartments 122 are spaced apart from each other along a lateral axis A2. Further, each set includes the multiple battery compartments 122 that are disposed adjacent to each other along a longitudinal axis A1. However, the battery compartments 122 may be arranged in an other format.

The present disclosure is related to a ventilation system 200 for the battery system 120 of the locomotive 102. The battery system 120 further includes the ventilation system 200 for the number of battery compartments 122. The ventilation system 200 maintains a temperature of the battery system 120 within desired operating limits. The ventilation system 200 is used to direct an air flow 10 (shown in FIG. 8A) towards the number of battery compartments 122. The air flow 100 includes a cooling air flow or a warm air flow to maintain the temperature of the battery system 120 within desired operating limits. In an example, the air flow 10 may be the cooling air flow that is directed towards the number of battery compartments 122 to prevent the battery system 120 from overheating. In another example, the air flow 10 may be the warm air flow towards the number of battery compartments 122 to warm up the battery system 120 in cold conditions. In an example, the 200 may be controlled by a main controller (not shown) onboard the locomotive 102 based on data reported by a battery management system (not shown) associated with the battery system 120.

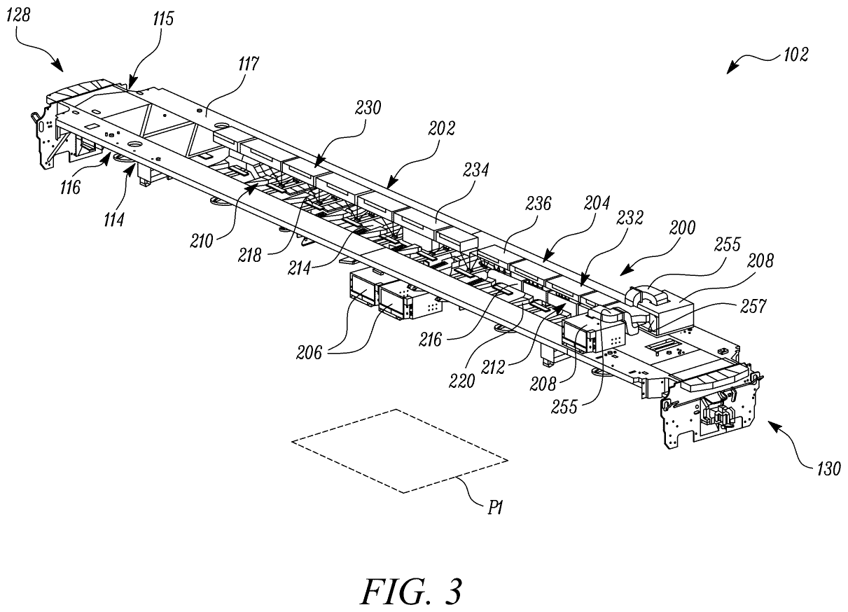

Referring to FIG. 3, a schematic perspective view of the ventilation system 200 is illustrated. The ventilation system 200 includes one or more duct assemblies 202, 204. In the illustrated example of FIG. 3, the one or more duct assemblies 202, 204 include a first duct assembly 202. The first duct assembly 202 is disposed proximal to the first end 128 of the underframe 114. The one or more duct assemblies 202, 204 further includes a second duct assembly 204. The second duct assembly 204 is disposed proximal to the second end 130 of the underframe 114.

The one or more duct assemblies 202, 204 includes one or more heat, ventilation, and air conditioning (HVAC) units 206, 208 to generate and supply the air flow 10 (see FIG. 8A) towards the number of battery compartments 122 of the battery system 120 (see FIG. 2). The HVAC units 206, 208 may receive ambient air therein and treat the ambient air to generate the air flow 10. The one or more HVAC units 206, 208 regulate a temperature, a humidity, and an air quality within a given space and help to maintain a desired temperature by removing excess heat from air.

In the illustrated example of FIG. 3, the first duct assembly 202 is larger in size and capacity than the second duct assembly 204, as the first duct assembly 202 is coupled with a higher number of battery compartments 122 to supply the air flow 10 thereto. Whereas the second duct assembly 204 is smaller in size and capacity than the first duct assembly 202, as the second duct assembly 204 is coupled with a lower number of battery compartments 122 to supply the air flow 10 thereto.

The first duct assembly 202 of the one or more duct assemblies 202, 204 includes the one or more HVAC units 206. Further, the one or more HVAC units 206 of the first duct assembly 202 includes two or more HVAC units 206 disposed adjacent to each other along a longitudinal plane P1 of the locomotive 102 or four or more HVAC units 206 disposed adjacent to each other along the longitudinal plane P1. In the illustrated example of FIG. 3, the one or more HVAC units 206 are four HVAC units 206. Further, the one or more HVAC units 206 of the first duct assembly 202 are disposed at the underside 116 of the underframe 114, or within the underframe 114.

Furthermore, the second duct assembly 204 of the one or more duct assemblies 202, 204 includes the one or more HVAC units 208. Further, the one or more HVAC units 208 of the second duct assembly 204 includes a single HVAC unit 208 or two or more HVAC units 208 disposed adjacent to each other along the longitudinal plane P1 of the locomotive 102. In the illustrated example of FIG. 3, the one or more HVAC units 208 are two HVAC units 208. Further, the one or more HVAC units 208 of the second duct assembly 204 are disposed at the top side 115 of the underframe 114. Specifically, the one or more HVAC units 208 are supported on the deck 117.

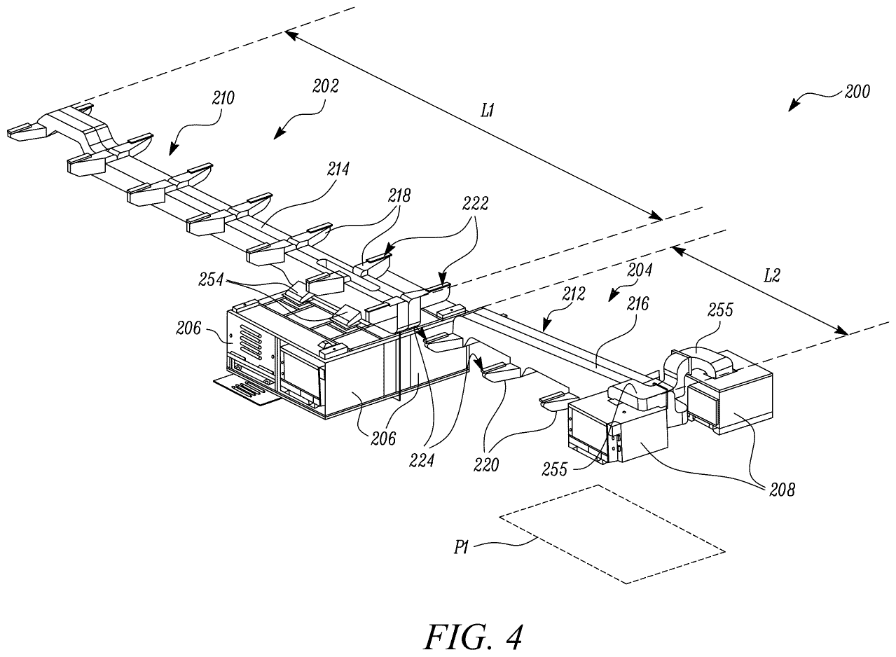

FIG. 4 is a schematic perspective view of an inlet assembly 210, 212 of the ventilation system 200 of FIG. 3. Referring to FIGS. 3 and 4, the one or more duct assemblies 202, 204 also includes the inlet assembly 210, 212 to direct the air flow 10 (see FIG. 8A) towards each of the number of battery compartments 122 (see FIG. 2). Specifically, the first duct assembly 202 includes the inlet assembly 210, and the second duct assembly 204 includes the inlet assembly 212.

The inlet assembly 210 of the first duct assembly 202 defines a first length L1 and the inlet assembly 212 of the second duct assembly 204 defines a second length L2. In the illustrated example of FIGS. 3 and 4, the first length L1 is greater than the second length L2.

Referring now to FIG. 4, the inlet assembly 210, 212 includes an inlet manifold 214, 216 in fluid communication with the one or more HVAC units 206, 208. Specifically, the inlet assembly 210 includes the inlet manifold 214 in fluid communication with the one or more HVAC units 206 and the inlet assembly 212 the inlet manifold 216 in fluid communication with the one or more HVAC units 208.

The inlet manifold 214, 216 of the inlet assembly 210, 212 is disposed within the underframe 114 (see FIG. 3) of the locomotive 102 (see FIG. 2) and/or the inlet manifold 214, 216 of the inlet assembly 210, 212 is mounted on the deck 117 (see FIG. 2) defined by the underframe 114. Specifically, the inlet manifold 214 of the inlet assembly 210 of the first duct assembly 202 is disposed within the underframe 114 of the locomotive 102 and the inlet manifold 216 of the inlet assembly 212 of the second duct assembly 204 is mounted on the deck 117 defined by the underframe 114.

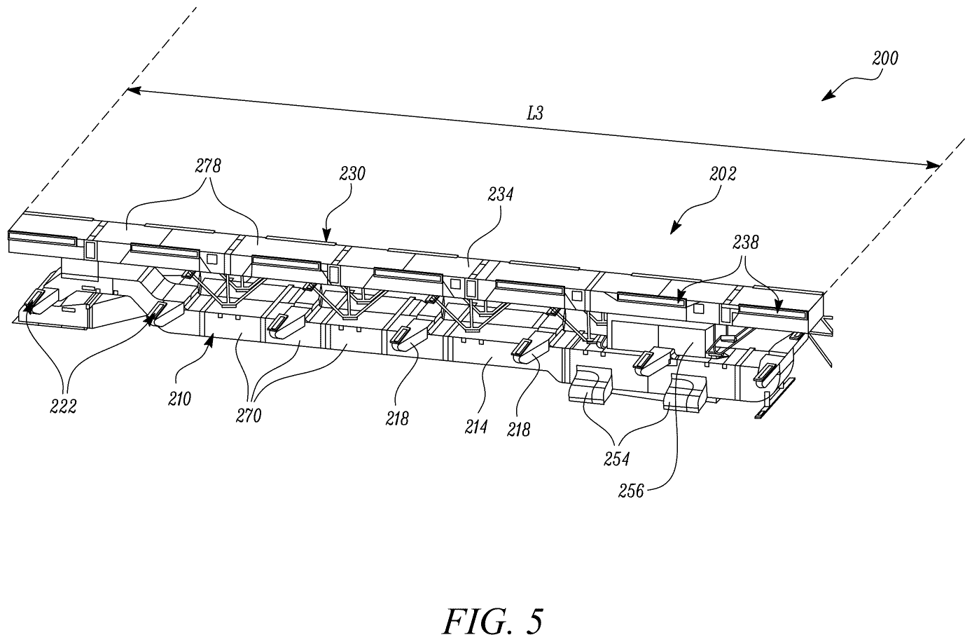

Further, as shown in FIG. 5, the inlet manifold 214 includes a number of sliced portions 270 which divides the inlet manifold 214 into multiple sections.

Referring again to FIG. 4, the first duct assembly 202 includes a number of inlet connecting ducts 254 that fluidly couple the one or more HVAC units 206 with the inlet assembly 210. Specifically, the number of inlet connecting ducts 254 are four inlet connecting ducts 254 (only two of them are visible, the others are hidden from view). However, the number of inlet connecting ducts 254 may be any number of inlet connecting ducts 254, as per a total number of the HVAC units 206.

Similarly, the second duct assembly 204 includes a number of inlet connecting ducts 255 that fluidly couple the one or more HVAC units 208 with the inlet assembly 212. Specifically, the number of inlet connecting ducts 255 are two inlet connecting ducts 255. However, the number of inlet connecting ducts 255 may be any number of inlet connecting ducts 255, as per a total number of the HVAC units 208.

The inlet assembly 210, 212 also includes a number of inlet ducts 218, 220 extending from the inlet manifold 214, 216. Specifically, the inlet assembly 210 includes the number of inlet ducts 218 extending from the inlet manifold 214 and the inlet assembly 212 includes the number of inlet ducts 220 extending from the inlet manifold 216.

In the illustrated example of FIG. 4, the number of inlet ducts 218 are fourteen inlet ducts 218. In the illustrated example of FIG. 4, the number of inlet ducts 220 are eight inlet ducts 220 (only three of which are visible in FIG. 4, the others are hidden from view). However, a total number of the inlet ducts 218, 220 may vary based on a total number of battery compartments 122, as per application requirements.

Each of the number of inlet ducts 218, 220 fluidly couples the inlet manifold 214, 216 with a corresponding battery compartment 122 (see FIG. 2) from the number of battery compartments 122. Further, the number of inlet ducts 218, 220 define a corresponding number of inlet ports 222, 224. Each inlet port 222, 224 is in fluid communication with a corresponding battery compartment 122. Specifically, each inlet duct 218 defines the corresponding inlet port 222 and each inlet duct 220 defines the corresponding inlet port 224.

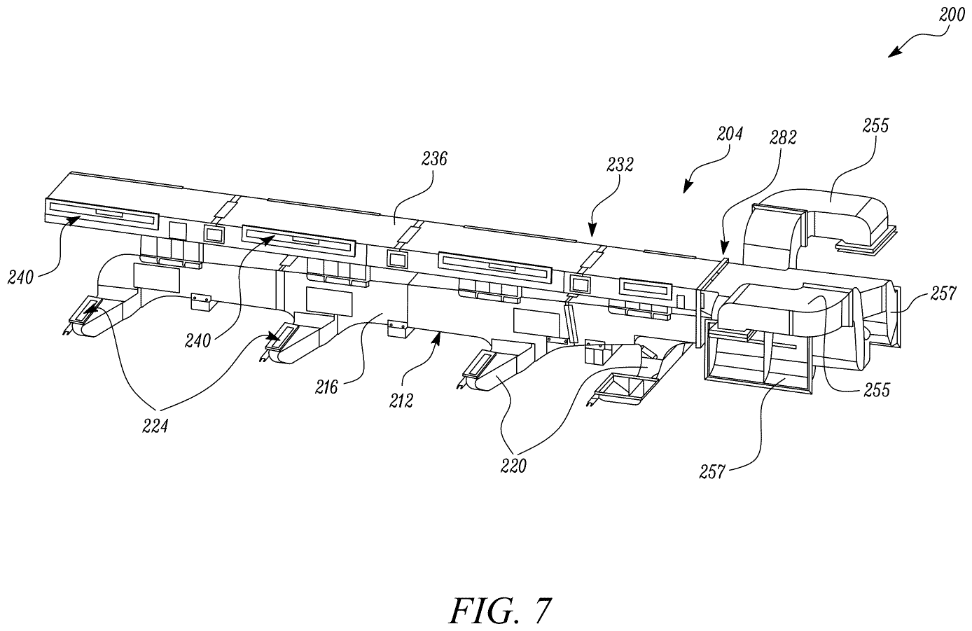

A size of some of the number of inlet ports 222, 224 of the number of inlet ducts 218, 220 is different from other inlet ports 222, 224 of the number of inlet ducts 218, 220. Specifically, a pair of inlet ports 224 of the inlet ducts 220 that are disposed proximal to the HVAC units 208 of the second duct assembly 204 are larger in size (see FIG. 7) from the inlet ports 222, 224 of the remaining number of inlet ducts 218, 220.

Alternatively, the size of each of the number of inlet ports 222, 224 of the number of inlet ducts 218, 220 may be same. The present disclosure is not limited to the size of the number of inlet ports 222, 224 of the number of inlet ducts 218, 220.

In the illustrated example of FIG. 4, the number of inlet ports 222, 224 are rectangular in shape. However, the number of inlet ports 222, 224 may have any other shape, as per application requirements.

Referring again to FIG. 3, the one or more duct assemblies 202, 204 further includes an outlet assembly 230, 232 to receive a return air flow 20 (shown in FIG. 8B) from the number of battery compartments 122 (see FIG. 2). Specifically, the first duct assembly 202 includes the outlet assembly 230, and the second duct assembly 204 includes the outlet assembly 232. In an example, when the ventilation system 200 is used to reduce the temperature of the battery compartments, the return air flow 20 has a higher temperature than the air flow 10 based on an exchange of heat with the battery compartments 122. Further, when the ventilation system 200 is used to increase the temperature of the battery compartments, the return air flow 20 has a lower temperature than the air flow 10 based on an exchange of heat with the battery compartments 122.

The outlet assembly 230 of the first duct assembly 202 defines a third length L3 (shown in FIG. 5) and the outlet assembly 232 of the second duct assembly 204 defines a fourth length L4 (shown in FIG. 6). The third length L3 is greater than the fourth length L4.

The outlet assembly 230, 232 includes an outlet manifold 234, 236 in fluid communication with the one or more HVAC units 206, 208. Specifically, the outlet assembly 230 includes the outlet manifold 234 in fluid communication with the one or more HVAC units 206 and the outlet assembly 232 includes the outlet manifold 236 in fluid communication with the one or more HVAC units 208. In the illustrated example of FIG. 3, the outlet manifold 234 of the outlet assembly 230 of the first duct assembly 202 is mounted on the deck 117 defined by the underframe 114. Further, the outlet manifold 234 is mounted on top of the inlet manifold 214. Further, the outlet manifold 236 of the outlet assembly 232 of the second duct assembly 204 is also mounted on the deck 117. Moreover, the outlet manifold 236 is mounted on top of the inlet manifold 216.

With reference to FIG. 5, the first duct assembly 202 also includes one or more outlet connecting ducts 256 that fluidly couple the one or more HVAC units 206 with the outlet assembly 230. Moreover, the second duct assembly 204 also includes one or more outlet connecting ducts 257 (shown in FIG. 3) that fluidly couple the one or more HVAC units 208 with the outlet assembly 232.

Further, the outlet manifold 234 includes a number of sliced portions 278 which divides the outlet manifold 234 into multiple sections.

Referring to FIGS. 5, 6, and 7, the outlet assembly 230, 232 further includes a number of outlet ports 238, 240 coupled to the outlet manifold 234, 236. Specifically, the outlet assembly 230 includes the number of outlet ports 238 coupled to the outlet manifold 234 and the outlet assembly 232 includes the number of outlet ports 240 coupled to the outlet manifold 236.

Each of the number of outlet ports 238, 240 fluidly couples the outlet manifold 234, 236 with a corresponding battery compartment 122 from the number of battery compartments 122. A total number of the outlet ports 238, 240 may vary based on the total number of battery compartments 122, as per application requirements. In the illustrated example of FIGS. 5, 6, and 7, a pair of the outlet ports 240 disposed proximal to the HVAC units 208 are smaller in size (see FIG. 7) than other remaining outlet ports 238, 240. In some examples, the size of the outlet ports 238, 240 may be same, without limiting the scope of the present disclosure.

Further, as shown in FIG. 7, the inlet manifold 216 of the second duct assembly 204 includes a single large, welded duct that is divided into two sections at a junction 282. Furthermore, the outlet manifold 236 of the second duct assembly 204 includes a single large, welded duct that is divided into two sections at the junction 282.

With reference to FIG. 8A, the one or more duct assemblies 202, 204 (see FIG. 3) further includes a distribution tower 260 coupled to each of the number of battery compartments 122. The distribution tower 260 is in fluid communication with the number of inlet ducts 218, 220 (see FIG. 4) and the number of battery compartments 122 to distribute the air flow 10 to the number of battery modules 124 of a corresponding battery compartment 122 from the number of battery compartments 122.

The distribution tower 260 is fluidly coupled with the number of inlet ports 222, 224 to receive and distribute the air flow 10 to the number of battery modules 124 (see FIG. 6) of the corresponding battery compartment 122 from the number of battery compartments 122. Specifically, the distribution tower 260 is fluidly coupled with the number of inlet ports 222, 224 (see FIG. 4) proximal to the bottom surface 142 of the housing 125 of the corresponding battery compartment 122 to receive and distribute the air flow 10 to the number of battery modules 124 of the corresponding battery compartment 122.

With reference to FIG. 8B, each of the outlet ports 238, 240 (see FIGS. 5 and 7) are fluidly coupled with the rear surface 146 of the housing 125 of the battery compartment 122. The return air flow 20 from the battery compartment 122 is received within the number of outlet ports 238, 240, via a number of fluid passages of the housing 125 of the battery compartment 122.

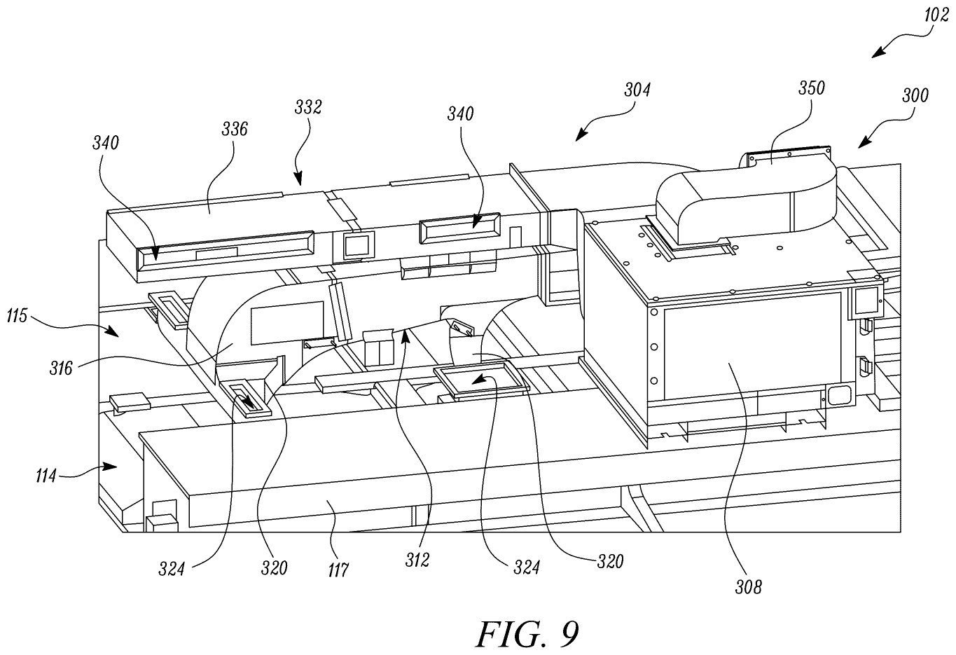

Referring to FIG. 9, a schematic perspective view of a ventilation system 300 is illustrated, according to another example of the present disclosure. The ventilation system 300 is substantially similar to the ventilation system 200 (see FIGS. 1 to 8B), with common components being referred to by the same numerals. The ventilation system 300 includes a duct assembly 304. The duct assembly 304 is substantially similar to the duct assembly 204 (see FIGS. 3 to 8B), with common components being referred to by the same numerals.

The duct assembly 304 includes one or more HVAC units 308 to generate and supply the air flow 10 (see FIG. 8A) towards the number of battery compartments 122 (see FIG. 2) of the battery system 120 (see FIG. 2). In the illustrated example of FIG. 9, the one or more HVAC units 308 is a single HVAC unit 308. The one or more HVAC units 308 is hereinafter interchangeably referred to as “the HVAC unit 308”. The HVAC unit 308 is disposed on the deck 117 of the underframe 114.

The duct assembly 304 includes an inlet assembly 312. The inlet assembly 312 includes an inlet manifold 316 in fluid communication with the HVAC unit 308. The inlet manifold 316 is mounted on the deck 117 defined by the underframe 114.

Further, the duct assembly 304 includes an inlet connecting duct 350 that fluidly couples the HVAC unit 308 with the inlet assembly 312. The inlet manifold 316 of the inlet assembly 312 is in fluid communication with the HVAC unit 308 via the inlet connecting duct 350.

The inlet assembly 312 also includes a number of inlet ducts 320 extending from the inlet manifold 316. Each of the number of inlet ducts 320 fluidly couples the inlet manifold 316 with a corresponding battery compartment 122 from the number of battery compartments 122. In the illustrated example of FIG. 9, the number of inlet ducts 320 are four inlet ducts 320 (only two of them are visible, the others are hidden from view). However, a total number of the inlet ducts 320 may vary as per the total number of the battery compartments 122, as per application requirements.

Further, each of the number of inlet ducts 320 defines an inlet port 324 that is in fluid communication with a corresponding battery compartment 122. In the illustrated example of FIG. 9, the number of inlet ports 324 are rectangular in shape. However, the number of inlet ports 224 may have any other shape, as per application requirements.

Further, a size of some of the number of inlet ports 324 is different from other inlet ports 324. Specifically, a pair of inlet ports 324 disposed proximal to the HVAC unit 308 have a different size from the remaining inlet ports 324. In the illustrated example of FIG. 9, the size of the pair of inlet ports 324 disposed proximal to the HVAC unit 308 is larger than the remaining inlet ports 324. However, the size of all the number of inlet ports 324 may be same, as per application requirements.

The duct assembly 304 further includes an outlet assembly 332 to receive the return air flow 20 (see FIG. 8B) from the number of battery compartments 122. The outlet assembly 332 includes an outlet manifold 336 in fluid communication with the HVAC unit 308. The outlet manifold 336 is disposed at the top side 115 of the underframe 114 and is mounted on the inlet manifold 316 of the inlet assembly 312.

The duct assembly 304 further includes an outlet connecting duct (not shown) that fluidly couples the outlet assembly 332 with the HVAC unit 308. The outlet manifold 336 of the outlet assembly 332 is in fluid communication with the HVAC unit 308 via the outlet connecting duct.

Further, the outlet assembly 332 includes a number of outlet ports 340 coupled to the outlet manifold 336. Each of the number of outlet ports 340 fluidly couples the outlet manifold 336 with a corresponding battery compartment 122 from the number of battery compartments 122. In the illustrated example of FIG. 9, the number of outlet ports 340 are four outlet ports 340. However, the number of outlet ports 340 may have any number of outlet ports 340, as per application requirements. In the illustrated example of FIG. 9, a pair of outlet ports 340 disposed proximal to the HVAC unit 308 are smaller in size than the other outlet ports 340. In some examples, the size of the outlet ports 340 may be same, without limiting the scope of the present disclosure.

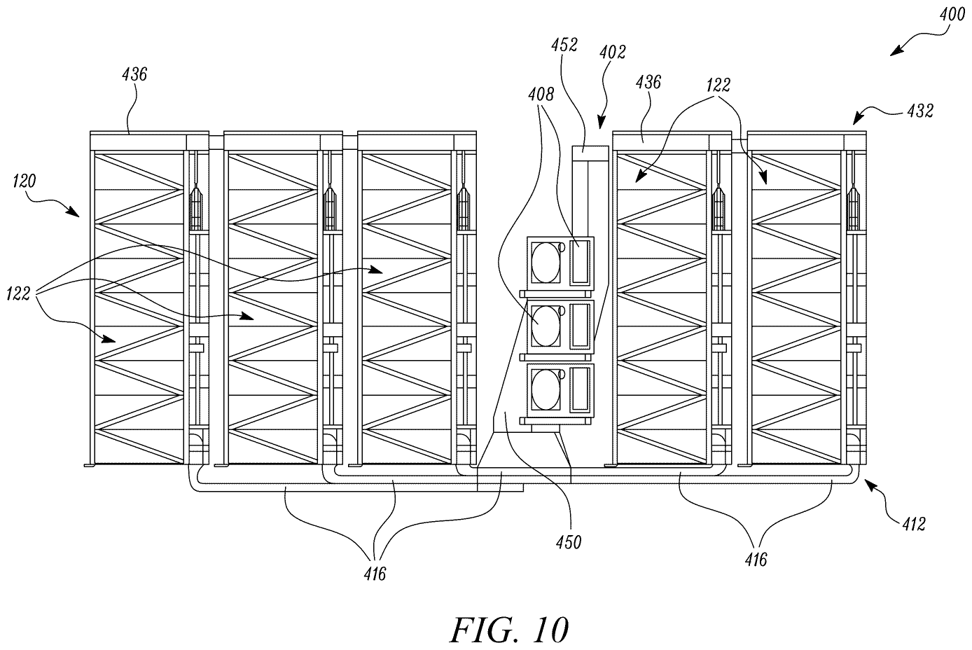

Referring to FIG. 10, a schematic front view of a ventilation system 400 is illustrated, according to yet another example of the present disclosure. The ventilation system 400 is substantially similar to the ventilation system 200 (see FIGS. 1 to 8B), with common components being referred to by the same numerals. The ventilation system 400 is compatible with two or more sets of battery compartments 122.

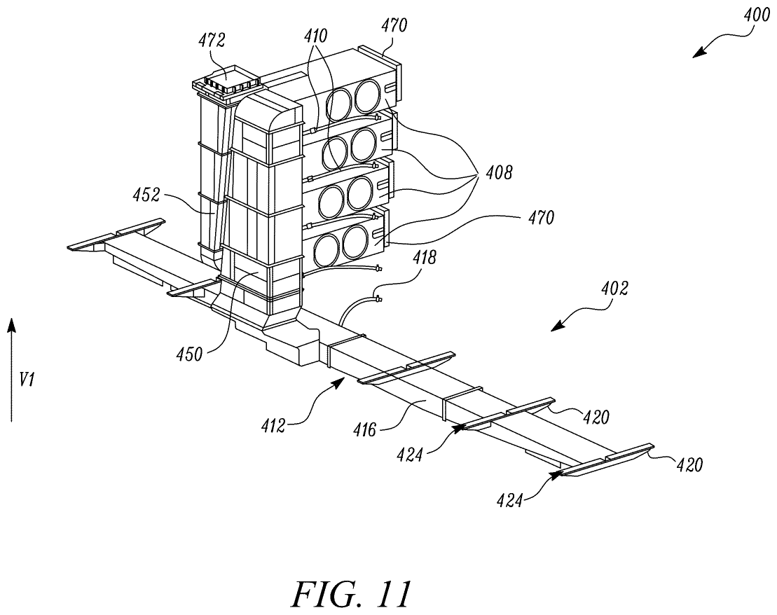

The ventilation system 400 includes one or more duct assemblies 404. With reference to FIGS. 10 and 11, the one or more duct assemblies 404 includes one or more HVAC units 408 to generate and supply the air flow 10 towards the number of battery compartments 122 of the battery system 120. The one or more HVAC units 408 includes two or more HVAC units 408 disposed in a stacked arrangement. In the illustrated example of FIGS. 10 and 11, the two or more HVAC units 408 are four HVAC units 408 disposed in a stacked arrangement along a vertical axis V1. However, the one or more HVAC units 408 may have any number of HVAC units 408 based on the total number of the battery compartments 122. Further, the one or more HVAC units 408 are disposed at the top side 115 of the underframe 114 and are mounted on the deck 117.

Furthermore, the one or more HVAC units 408 includes a number of water drain hoses 410 to remove excess water that is generated when the ventilation system 400 is in operation. Further, the number of water drain hoses 410 may also be used in the HVAC units 206, 208, 308 (see FIGS. 2 to 9) of the above discussed embodiments.

The one or more duct assemblies 404 includes an inlet assembly 412 to direct the air flow 10 (see FIG. 8A) towards each of the number of battery compartments 122. The inlet assembly 412 includes an inlet manifold 416 in fluid communication with the one or more HVAC units 408. The inlet manifold 416 is disposed within the underframe 114 (see FIG. 2).

Further, the inlet manifold 416 includes a number of water drain hoses 418 to remove excess water that is generated in the inlet manifold 416 when the ventilation system 400 is in operation. However, the number of water drain hoses 418 may also be used in the inlet manifolds 214, 216, 316 (see FIGS. 2 to 9) of the above discussed embodiments.

The inlet assembly 412 also includes a number of inlet ducts 420 extending from the inlet manifold 416. Each of the number of inlet ducts 420 fluidly couples the inlet manifold 416 with a corresponding battery compartment 122 from the number of battery compartments 122. Further, each of the number of inlet ducts 420 defines an inlet port 424 that is in fluid communication with a corresponding battery compartment 122.

Further, the one or more duct assemblies 404 includes an inlet tower 450 that fluidly couples the one or more HVAC units 408 with the inlet assembly 412. The inlet manifold 416 of the inlet assembly 412 is in fluid communication with each of the four HVAC units 408 via the inlet tower 450.

The one or more duct assemblies 404 further includes an outlet assembly 432 to receive the return air flow 20 (see FIG. 8B) from the number of battery compartments 122. The outlet assembly 432 includes an outlet manifold 436 in fluid communication with the one or more HVAC units 408. In the illustrated example of FIGS. 10 and 11, the outlet manifold 436 includes two outlet manifolds 436 to receive the return air flow 20 from the number of battery compartments 122. One outlet manifold 436 is associated with one set of battery compartments 122 and another outlet manifold 436 is associated with another set of battery compartments 122. Further, the duct assembly 404 may include any number of outlet manifolds 436 based on the number of sets of battery compartments 122.

The one or more duct assemblies 404 further includes an outlet tower 452 that fluidly couples the outlet assembly 432 with the one or more HVAC units 408. The outlet manifold 436 of the outlet assembly 432 is in fluid communication with each of the four HVAC units 408 via the outlet tower 452.

Further, the outlet assembly 432 includes a number of outlet ports (not shown) coupled to the outlet manifold 436. Each of the number of outlet ports fluidly couples the outlet manifold 436 with a corresponding battery compartment 122 from the number of battery compartments 122.

Referring now to FIG. 11, a schematic perspective view of a portion of the ventilation system 400 is illustrated. The one or more duct assemblies 404 further includes an air inlet filter 470 coupled to the one or more HVAC units 408 in a path along which ambient air enters the one or more HVAC units 408. Further, the one or more duct assemblies 404 includes an air outlet filter 472 in fluid communication with the one or more HVAC units 408 and disposed in a path along which the return air flow 20 from the outlet assembly 432 enters the one or more HVAC units 408. The air outlet filter 472 is coupled to the outlet tower 452.

However, an air inlet filter and an air outlet filter may also be used in a path along which ambient air enters the HVAC units 206, 208, 308, 408 and a path along which the return air flow 20 from the outlet assembly 230, 232, 332, 432 enters the HVAC units 206, 208, 308, 408 in the above discussed embodiments.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the ventilation system 200, 300, 400 for the battery system 120 of the locomotive 102. The ventilation system 200, 300, 400 is an air-forced convection ventilation system, which includes a meticulous design to ensure optimal airflow distribution across all battery compartments 122. The battery compartments 122 are modular, therefore in case some of the compartments are not assembled, the ventilation system 200, 300, 400 will still work properly. The ventilation system 200, 300, 400 presents a practical and efficient solution for managing battery temperature in locomotives, while optimizing performance, reducing operational costs, and ensuring long-term reliability.

The ventilation system 200, 300, 400 includes the one or more duct assemblies 202, 204, 304, 404. The one or more duct assemblies 202, 204, 304, 404 includes the one or HVAC units 206, 208, 308, 408, the inlet assembly 210, 212, 312, 412 to direct the air flow 10 towards each of the number of battery compartments 122, and the outlet assembly 230, 232, 332, 432 to receive the return air flow 20 from the number of battery compartments 122. The one or more duct assemblies 202, 204, 304, 404 of the ventilation system 200, 300, 400 may use the ambient air to generate and supply the air flow 10 towards the number of battery compartments 122 of the battery system 120 to reduce the temperature of the battery system 120. Thus, the ventilation system 200, 300, 400 prevents the battery system 120 from overheating and maintains the temperature of the battery system 120 within predefined limits to ensure optimal operation of the battery system 120, improve traction power, and increase a lifespan of the battery system 120.

Further, the inlet manifolds 214, 216, 316, 416 are designed in a way to improve a distribution of air flow towards the battery compartments 122. Specifically, the components of each of the duct assemblies 202, 204, 304, 404 are designed to allow equal airflow distribution across the duct assemblies 202, 204, 304, 404, to ensure equal airflow to each battery compartment 122.

In an example, an inside geometry of the inlet manifolds 214, 216, 316, 416 may be built with curved sheet metals to avoid undesirable recirculation of air flow and with specific inside features that allow the same amount of air flow to reach each battery compartment 122.

Further, outer faces of the duct assemblies 202, 204, 304, 404 may be covered with insulators to eliminate heat exchange with surroundings, therefore improving an efficiency of the ventilation system 200, 300, 400. In an example, to minimize heat exchange with the surroundings, all components of the duct assemblies 202, 204, 304, 404 are insulated with closed-cell foam featuring a reinforced aluminum foil face and double-sided adhesive backing. Thus, the components of the duct assemblies 202, 204, 304, 404 are thermally insulated to increase the efficiency of the ventilation system 200, 300, 400, whether the ventilation system 200, 300, 400 is warming or cooling the battery compartments 122.

Moreover, the components of the duct assemblies 202, 204, 304, 404 may be made of metals or alloys, which may be robust against the high-temperature and may prevent leaks from the ventilation system 200, 300, 400.

In an example, the components of the duct assemblies 202, 204, 304, 404 may be built with thin sheets of standard steel, which may be cheaper compared to special duct material or Aluminum. Even though the inlet manifolds 214, 216, 316, 416 are made from thin sheets, the inlet manifolds 214, 216, 316, 416 may provide greater resistance and rigidity because of their robust design. Further, the air inlet filter 470 and the air outlet filter 472 may protect the HVAC units 206, 208, 308, 408 from any impurities present in air entering the HVAC units 206, 208, 308, 408.

Further, the inlet manifold, such as the inlet manifold 214, and the outlet manifold, such as the outlet manifold 234, may include the sliced portions 270, 278 to allow easier assembly. Specifically, the sliced portions 270, 278 may improve flexibility during construction, maintenance, and replacement of one or more components of the ventilation system 200, 300, 400.

Overall, the ventilation system 200, 300, 400 may have a robust design, may be simple in construction, may be cost-effective, and may be durable. Moreover, the ventilation system 200, 300, 400 may provide flexibility by providing different available options that may be used on a variety of battery systems.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A ventilation system for a battery system of a locomotive, the ventilation system comprising:
at least one duct assembly including:
at least one heat, ventilation, and air conditioning (HVAC) unit adapted to generate and supply an air flow towards a plurality of battery compartments of the battery system;
an inlet assembly adapted to direct the air flow towards each of the plurality of battery compartments, wherein the inlet assembly includes:
an inlet manifold in fluid communication with the at least one HVAC unit; and
a plurality of inlet ducts extending from the inlet manifold, wherein each of the plurality of inlet ducts fluidly couples the inlet manifold with a corresponding battery compartment from the plurality of battery compartments; and
an outlet assembly adapted to receive a return air flow from the plurality of battery compartments, wherein the outlet assembly includes:
an outlet manifold in fluid communication with the at least one HVAC unit; and
a plurality of outlet ports coupled to the outlet manifold, wherein each of the plurality of outlet ports fluidly couples the outlet manifold with a corresponding battery compartment from the plurality of battery compartments.

2. The ventilation system of claim 1, wherein the at least one duct assembly includes a first duct assembly, wherein the inlet assembly of the first duct assembly defines a first length, wherein the at least one duct assembly includes a second duct assembly, wherein the inlet assembly of the second duct assembly defines a second length, and wherein the first length is greater than the second length.

3. The ventilation system of claim 1, wherein the at least one duct assembly further includes a distribution tower coupled to each of the plurality of battery compartments, and wherein the distribution tower is in fluid communication with the plurality of inlet ducts and the plurality of battery compartments to distribute the air flow to a plurality of battery modules of a corresponding battery compartment from the plurality of battery compartments.

4. The ventilation system of claim 1, wherein the plurality of inlet ducts define a corresponding plurality of inlet ports, wherein each inlet port is in fluid communication with a corresponding battery compartment, and wherein a size of some of the plurality of inlet ports of the plurality of inlet ducts is different from other inlet ports of the plurality of inlet ducts.

5. The ventilation system of claim 4, wherein a size of each of the plurality of inlet ports of the plurality of inlet ducts is same.

6. The ventilation system of claim 1, wherein the inlet manifold of the inlet assembly is disposed within an underframe of the locomotive and/or the inlet manifold of the inlet assembly is mounted on a deck defined by the underframe.

7. The ventilation system of claim 1, wherein the at least one duct assembly further includes:
an air inlet filter coupled to the at least one HVAC unit in a path along which ambient air enters the at least one HVAC unit; and
an air outlet filter in fluid communication with the at least one HVAC unit and disposed in a path along which the return air flow from the outlet assembly enters the at least one HVAC unit.

8. The ventilation system of claim 1, wherein the at least one duct assembly further includes an inlet tower that fluidly couples the at least one HVAC unit with the inlet assembly, and wherein the inlet manifold of the inlet assembly is in fluid communication with the at least one HVAC unit via the inlet tower; and

9. The ventilation system of claim 1, wherein the at least one duct assembly further includes an outlet tower that fluidly couples the outlet assembly with the at least one HVAC unit, and wherein the outlet manifold of the outlet assembly is in fluid communication with the at least one HVAC unit via the outlet tower.

10. The ventilation system of claim 1, wherein the air flow includes a cooling air flow or a warm air flow to maintain a temperature of the battery system within desired operating limits.

11. A battery system of a locomotive, the battery system comprising:
a plurality of battery compartments; and
a ventilation system for the plurality of battery compartments, the ventilation system including:
at least one duct assembly including:
at least one heat, ventilation, and air conditioning (HVAC) unit adapted to generate and supply an air flow towards plurality of battery compartments of the battery system;
an inlet assembly adapted to direct the air flow towards each of the plurality of battery compartments, wherein the inlet assembly includes:
an inlet manifold in fluid communication with the at least one HVAC unit; and
a plurality of inlet ducts extending from the inlet manifold, wherein each of the plurality of inlet ducts fluidly couples the inlet manifold with a corresponding battery compartment from the plurality of battery compartments; and
an outlet assembly adapted to receive a return air flow from the plurality of battery compartments, wherein the outlet assembly includes:
an outlet manifold in fluid communication with the at least one HVAC unit; and
a plurality of outlet ports coupled to the outlet manifold, wherein each of the plurality of outlet ports fluidly couples the outlet manifold with a corresponding battery compartment from the plurality of battery compartments.

12. The battery system of claim 11, wherein the at least one duct assembly includes a first duct assembly, wherein the inlet assembly of the first duct assembly defines a first length, wherein the at least one duct assembly includes a second duct assembly, wherein the inlet assembly of the second duct assembly defines a second length, and wherein the first length is greater than the second length.

13. The battery system of claim 11, wherein the at least one duct assembly further includes a distribution tower coupled to each of the plurality of battery compartments, and wherein the distribution tower is in fluid communication with the plurality of inlet ducts and the plurality of battery compartments to distribute the air flow to a plurality of battery modules of a corresponding battery compartment from the plurality of battery compartments.

14. The battery system of claim 11, wherein the plurality of inlet ducts define a corresponding plurality of inlet ports, wherein each inlet port is in fluid communication with a corresponding battery compartment, and wherein a size of some of the plurality of inlet ports of the plurality of inlet ducts is different from other inlet ports of the plurality of inlet ducts.

15. The battery system of claim 14, wherein a size of each of the plurality of inlet ports of the plurality of inlet ducts is same.

16. The battery system of claim 11, wherein the inlet manifold of the inlet assembly is disposed within an underframe of the locomotive and/or the inlet manifold of the inlet assembly is mounted on a deck defined by the underframe.

17. The battery system of claim 11, wherein the at least one duct assembly further includes:
an air inlet filter coupled to the at least one HVAC unit in a path along which ambient air enters the at least one HVAC unit; and
an air outlet filter in fluid communication with the at least one HVAC unit and disposed in a path along which the return air flow from the outlet assembly enters the at least one HVAC unit.

18. The battery system of claim 11, wherein the at least one duct assembly further includes an inlet tower that fluidly couples the at least one HVAC unit with the inlet assembly, and wherein the inlet manifold of the inlet assembly is in fluid communication with the at least one HVAC unit via the inlet tower; and

19. The battery system of claim 11, wherein the at least one duct assembly further includes an outlet tower that fluidly couples the outlet assembly with the at least one HVAC unit, and wherein the outlet manifold of the outlet assembly is in fluid communication with the at least one HVAC unit via the outlet tower.

20. The battery system of claim 11, wherein the air flow includes a cooling air flow or a warm air flow to maintain a temperature of the battery system within desired operating limits.
